(19) United States
(12) Patent Application Publication
(10) Pub. No.: US 2018/0165349 A1
(43) Pub. Date: Jun. 14, 2018

(54) GENERATING AND ASSOCIATING TRACKING EVENTS ACROSS ENTITY LIFECYCLES

(71) Applicant: LinkedIn Corporation, Sunnyvale, CA (US)

(72) Inventor: William G. Vaughan, Mountain View, CA (US)

(73) Assignee: LinkedIn Corporation, Sunnyvale, CA (US)

(21) Appl. No.: 15/379,001

(22) Filed: Dec. 14, 2016

(51) Int. Cl. G06F 17/30; G06F 7/08

(52) U.S. Cl. CPC G06F 17/30598; G06F 7/08; G06F 17/30294; G06F 17/30876; G06F 17/30867

(57) ABSTRACT

The disclosed embodiments provide a system for processing data. During operation, the system provides a schema for including, by a set of components in a multi-tier architecture, a tracking identifier for an entity instance in the multi-tier architecture. Next, the system identifies, from a set of tracking events received from the multi-tier architecture, a subset of the tracking events containing the tracking identifier. The system then groups the subset of the tracking events into an entity lifecycle for the entity instance. Finally, the system outputs the entity lifecycle for use in assessing a performance of the multi-tier architecture by a consumer of tracking data.

### BACKGROUND

### Field

The disclosed embodiments relate to tracking of data. More specifically, the disclosed embodiments relate to techniques for generating and associating tracking events across entity lifecycles.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, data analytics may be used to assess past performance, guide business or technology planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools, relational databases, and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, complex data processing flows and entity lifecycles may involve numerous interconnected jobs, inputs, and outputs, which may be difficult to coordinate or track.

Consequently, big data analytics may be facilitated by mechanisms for efficiently collecting, storing, managing, compressing, transferring, sharing, analyzing, processing, defining, and/or visualizing large data sets.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows an exemplary sequence of operations involved in tracking entity lifecycles in a multi-tier architecture in accordance with the disclosed embodiments.

FIG. 4 shows a flowchart illustrating the processing of data in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

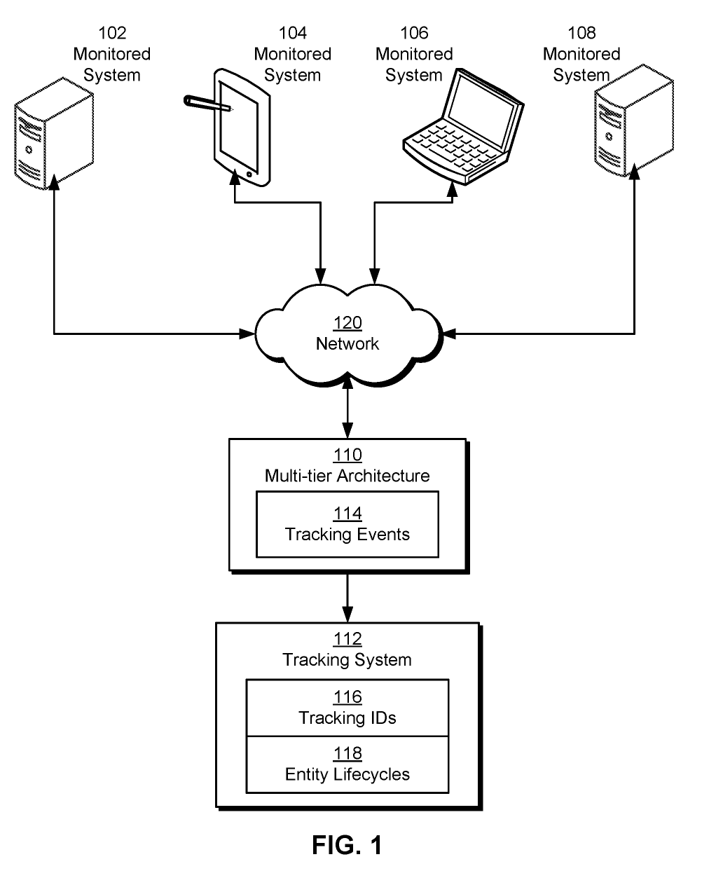

The disclosed embodiments provide a method, apparatus, and system for processing data. More specifically, the disclosed embodiments provide a method, apparatus, and system for generating and processing tracking data collected from a monitored system. As shown in FIG. 1, a tracking system 112 may receive tracking events 114 related to creation and/or use of entities in a multi-tier architecture 110 by a number of monitored systems 102-108.

Multi-tier architecture 110 may include multiple tiers in which components execute to implement client-server applications. For example, the multi-tier architecture may be used to execute a web application, one or more components of a mobile application, one or more services, and/or another type of client-server and/or distributed application that is accessed over a network 120. As a result, the multi-tier architecture may include one or more client, frontend, middle tier, and/or backend tiers. In turn, the monitored systems may be personal computers (PCs), laptop computers, tablet computers, mobile phones, portable media players, workstations, servers, gaming consoles, and/or other network-enabled computing devices that are capable of executing the application in one or more forms.

During execution of an application in multi-tier architecture 110, monitored systems 102-108 may generate tracking events 114 associated with processing requests, executing tasks, and/or other types of processing or execution. For example, a computing device that retrieves one or more pages (e.g., web pages) or screens of an application over network 120 may transmit tracking events related to loading of the pages, requesting of data associated with the pages, rendering of the data and/or pages, and/or views or actions related to the data and/or pages. The tracking events may be collected by tracking system 112 for subsequent storage, analysis, and/or use.

In addition, the operation of one or more monitored systems 102-108 may be tracked indirectly through tracking events 114 reported by other monitored systems. For example, the operation of a server in a data center may be partially or wholly monitored by collecting tracking events 114 from client computer systems, applications, and/or services that request pages, data, and/or application components from the server and/or data center.

Tracking events 114 from monitored systems 102-108 may be aggregated by tracking system 112 and/or another mechanism. For example, the tracking events may be aggregated into an event stream associated with multi-tier architecture 110. The tracking events may then be provided to tracking system 112 for grouping of the tracking events by tracking identifiers (IDs) 116 and the generation and/or analysis of entity lifecycles 118 using the tracking IDs, as described in further detail below.

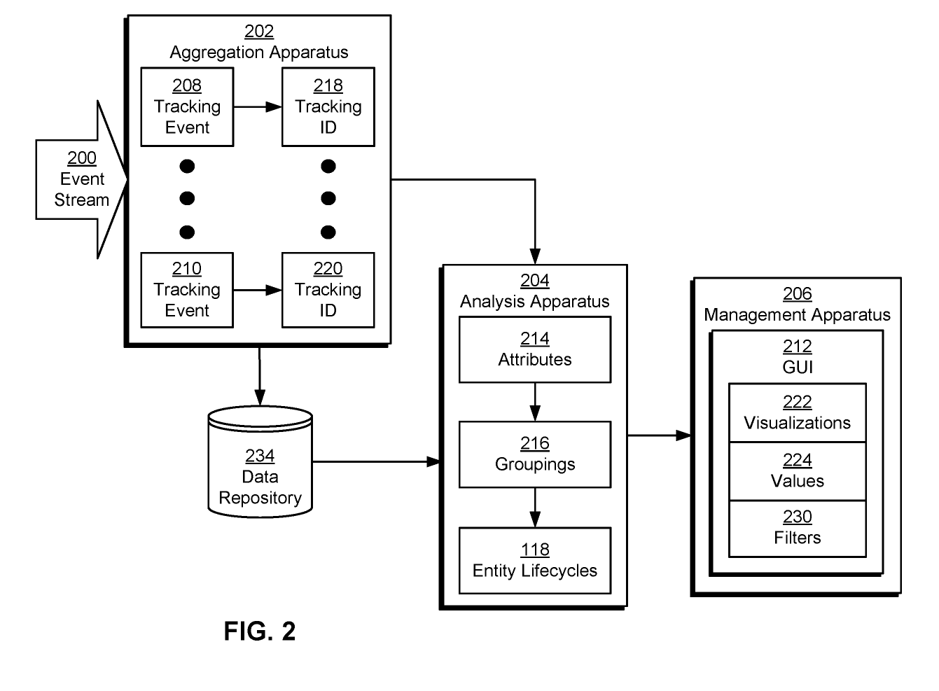

FIG. 2 shows a system for processing data in accordance with the disclosed embodiments. More specifically, FIG. 2 shows a tracking system, such as tracking system 112 of FIG. 1, that collects and analyzes tracking events 114 from a number of monitored systems. As shown in FIG. 2, the monitoring system includes an aggregation apparatus 202, an analysis apparatus 204, and a management apparatus 206. Each of these components is described in further detail below.

Aggregation apparatus 202 may obtain a number of tracking events 208-210 from an event stream 200. Each tracking event may represent a record of one or more loads, views, clicks, requests, responses, renders, interactions, and/or other activity on the monitored systems. As mentioned above, each tracking event may be generated by the monitored system in which the corresponding activity occurred, or the tracking event may be produced by another monitored system that indirectly detects the activity. Thus, for large numbers of monitored systems and/or monitored systems in a highly distributed system, aggregation apparatus 202 may receive large numbers (e.g., thousands) of event records from event stream 200 every second.

In addition, tracking events in event stream 200 may be obtained from multiple sources. For example, records of events associated with use of a website, web application, and/or other client-server interaction may be received from a number of clients, servers, and/or data centers hosting the website, which in turn may receive data used to populate the records from computer systems, mobile devices, and/or other electronic devices that interact with the website or web application. The records may be aggregated to event stream 200 for further processing by aggregation apparatus 202. In turn, aggregation apparatus 202 may perform grouping, ordering, and/or filtering of the records by subscribing to different types of events in the event stream; aggregating records of events along dimensions such as location, region, event type, service type, and/or time interval; and/or generating summary statistics such as medians, quantiles, variances, means, maximums, minimums, and/or counts from the records and/or metrics in the records.

Aggregation apparatus 202 may then store tracking events 208-210 in a data repository 234, such as a relational database, distributed filesystem, and/or other storage mechanism, for subsequent retrieval and use. A portion of the aggregated records and/or performance metrics may be transmitted directly to analysis apparatus 204 and/or another component of the system for real-time or near-real-time analysis by the component.

As discussed above, tracking events 208-210 may be used to monitor and/or track the execution of components in a multi-tier architecture. The components may include clients, frontend components, backend components, middle tier components, and/or other components involved in processing client-server interactions. For example, the multi-tier architecture may be used to provide a social network such as an online professional network. The online professional network may allow users to establish and maintain professional connections; list work and community experience; endorse, follow, message, and/or recommend one another; search and apply for jobs; and/or engage in other professional or social networking activity. Employers may list jobs, search for potential candidates, and/or provide business-related updates to users.

The online professional network may also display a content feed containing information that may be pertinent to users of the online professional network. For example, the content feed may be displayed within a website and/or mobile application for accessing the online professional network. Feed updates in the content feed may include posts, articles, scheduled events, impressions, clicks, likes, dislikes, shares, comments, mentions, views, updates, trending updates, conversions, and/or other activity or content by or about various entities (e.g., users, companies, schools, groups, skills, tags, categories, locations, regions, etc.). The feed updates may also include content items associated with the activities, such as user profiles, job postings, user posts, status updates, messages, sponsored content, event descriptions, articles, images, audio, video, documents, and/or other types of content from the content repository.

As a result, tracking events 208-210 may enable tracking and/or monitoring of the operation, execution, and/or use of components for accessing and/or using the online professional network. For example, tracking events may be used to monitor services, repositories, clients, servers, applications, and/or other components for generating job and/or connection recommendations, the content feed, user-interface elements, pages, and/or other features of the online professional network.

In one or more embodiments, the system of FIG. 2 includes functionality to generate, associate, and/or analyze tracking events 208-210 across entity lifecycles in the multi-tier architecture. The entity lifecycles may encompass entity instances such as individual resources, user-interface elements, pages, users, statistical models, data, and/or metadata used in the multi-tier architecture. For example, a series of tracking events may be used to monitor and/or record the materialization of a database record that is passed through a service call stack, returned to a client, and/or acted upon by a user of the client.

To enable tracking of the entity lifecycles, tracking events 208-210 may include tracking identifiers (IDs) 218-220 for the corresponding entity instances. For example, a primary key, Uniform Resource Identifier (URI), universally unique identifier (UUID), and/or another type of tracking ID may be generated for each entity instance created in the multi-tier architecture. As the entity instance transitions through different phases in its lifecycle, components that interact with and/or use the entity instance may generate tracking events representing the interaction and/or use.

To facilitate consistent tracking of entity lifecycles, the components may use a shared schema and/or interface to include the tracking ID in tracking events (e.g., tracking events 208-210). An exemplary schema for including tracking identifiers for entity instances in the multi-tier architecture may include the following:

{

“type”: “record”,
“name”: “TrackableEntity”,
“namespace”: “com.linkedin.common”,
“doc”: “Represents a particular instance of an entity. Should

be populated when an entity is materialized.”

“fields”: [ {

“type”: “fixed”,
“name”: “trackingId”,
“doc”: “a unique id which represents this particular instance

of an entity”,

“size”: 16

} ]

}

The above schema may be used to generate a record for an instance of a “TrackableEntity” in the multi-tier architecture at the time of creation and/or materialization of the instance. For example, a component used to create or materialize the instance may populate a “trackingId” field in the record with a unique 16-byte value by calling a common library and/or application-programming interface (API) for producing tracking IDs. The component may then create a tracking event representing the creation or materialization of the instance and include the tracking ID and/or record in the tracking event and/or other metadata for the instance.

The component may also include other information in the tracking event, such as a timestamp representing the time at which the corresponding activity took place, a processing time associated with the activity, an “event type” for the activity, an identifier for the component, an identifier for a user associated with the activity, an entity name, and/or other information or attributes 214 related to the activity, component, and/or instance. The information may alternatively be provided in another event or record that is generated and/or stored separately from the tracking event. The other event or record may also include the tracking ID to allow the information to be linked to the tracking event.

As the entity instance transitions between phases in its lifecycle, the tracking ID may be passed with the entity instance across components in the multi-tier architecture. For example, the tracking ID may be passed in a header and/or metadata for the entity instance for identification of the entity instance by components that subsequently use and/or interact with the entity instance. The tracking ID may also, or instead, be obtained by the components from previous tracking events for the entity instance (e.g., by subscribing to the tracking events in event stream 200) and/or in other data or metadata from other components that have previously used the entity instance. In turn, the components may include the tracking ID in additional tracking events for the entity instance to allow continued tracking of the entity instance through the entity lifecycle of the entity instance.

Conversely, the components may change the tracking ID when a different entity instance is deemed to have been created or used, either as a result of interacting with the original entity instance or independently of the use of the original entity instance. For example, the same tracking ID may be associated with a series of requests to one or more frontend, middle tier, and backend components in the multi-tier architecture as long as the requests are used to retrieve data associated with the same resource (e.g., page, database record, feed update, user-interface component, statistical model, etc.). Once a given request spawns a subsequent request for another resource (e.g., if a request for a feed update in a content feed produces another request for a statistical model used to select the feed update), a new tracking ID may be generated for the other resource and included in tracking events associated with the other resource.

Moreover, tracking IDs may decouple the identification and/or definition of entity instances from conventional identifiers associated with the entity instances. For example, a page in a web application may commonly be identified using a Uniform Resource Locator (URL) for the page. On the other hand, a modern single-page application (SPA) may load different screens containing user-interface elements and data within the same URL, which may interfere with the tracking of user interactions, views, navigation, and/or other activity within the SPA. Instead, an instance of a “page” in the SPA may be defined to exist until the SPA is refreshed using data from a server, a user has clicked and/or otherwise navigated to a different screen in the SPA, and/or the user has scrolled down past a certain point in the same screen of the SPA. In turn, the generation of tracking events 208-210 using configurable tracking IDs for page and/or other entity instances in the SPA may provide better flexibility, granularity, and/or accuracy of information than tracking individual page loads in the SPA.

After tracking events 208-210 are received, aggregated, and/or stored in data repository 234 by aggregation apparatus 202, analysis apparatus 204 may generate various groupings 216 of the tracking events by tracking IDs 218-220 and/or other attributes 214 in the tracking events. First, analysis apparatus 204 may group subsets of tracking events with the same tracking ID into an entity lifecycle for the corresponding entity instance. Within the grouping, analysis apparatus 204 may order the tracking events by timestamp, event type, and/or other attributes to produce a chronological view of the entity lifecycle. Thus, the tracking events may be used to construct a “flow” representing use of the entity instance by various components of the multi-tier architecture.

Second, analysis apparatus 204 may group tracking events 208-210 by event types, tracking scopes, and/or other attributes 214 in and/or associated with tracking events 208-210. Each tracking event may be associated with an event type that represents the type of activity recorded in the tracking event. For example, event types for tracking events 208-210 may include serving events representing serving of entity instances from servers to clients in request-response communications, rendering events representing rendering of entity instances on client devices, and/or view events representing display of entity instances in viewports. The event types may also include action events representing user actions (e.g., scrolling, clicking, logging in, logging off, opening a tab, opening a page, etc.), interaction events representing interactions among users or components (e.g., likes, comments, social network connection requests, messages, shares, follows, searches, request-response interactions, etc.), and/or navigation events (e.g., loading a page, navigating to another page, refreshing a page, etc.). The event type may be specified in a “topic” for the corresponding tracking events, which can be subscribed to by consumers of event stream 200. Alternatively, the event type may be included as a field in the tracking events.

Each tracking event may also be associated with one or more tracking scopes encompassed by different entity instances to which the tracking event applies. For example, the tracking event may include unique identifiers for a user session with the multi-tier architecture, a user-browser pair representing a particular user and web browser, a client-server session, a request, a page, a module in the page, and/or another entity involved in an activity recorded by the tracking event. The identifiers may be included in fields that identify the corresponding tracking scopes in the tracking event. One or more tracking scope identifiers may also be used as tracking IDs in the tracking event. For example, a tracking event representing a page load may include a tracking ID for a page instance being loaded, which may also function as a tracking scope ID for the tracking event and subsequent tracking events within the same page scope.”

Tracking IDs 218-220, event types, tracking scopes, and/or other attributes 214 of tracking events 208-210 may thus enable aggregation of tracking events 208-210 under different contexts and allow the tracking system to be easily adapted to new entity instances and/or changes in the definition or identification of existing entity instances. In turn, tracking events 208-210, attributes 214, groupings 216, and/or entity lifecycles 118 for related entity instances and/or event types may be used to identify, evaluate, and/or monitor the operation, execution, and/or performance of the multi-tier architecture in a fine-grained and/or flexible manner.

For example, a page instance in a web application may have a tracking ID that is created when a page is first loaded by a front-end and/or client component in the multi-tier architecture. The tracking ID may be included in a “page view event” representing the page load and combined with the page name of the page to represent the page instance. The tracking ID may also be used to define a “page scope” for subsequent tracking events involving the page instance.

As a result, the tracking ID may be included in subsequent tracking events associated with requests, responses, and/or other activity related to loading and/or interacting with individual modules in the page instance, even when the activity involves different components in the multi-tier architecture. Tracking events for request-response interactions that take place during loading of and/or interaction with the modules in the page instance may also include tracking IDs for the corresponding modules and/or resources, in lieu of or in addition to the tracking ID for the page instance.

Finally, a transition from the page instance to a subsequent page instance (e.g., during the loading of a different page) may be defined by a navigation event that includes the tracking ID of the page instance, as well as a different tracking ID for the subsequent page instance. The process may then be repeated for requests, responses, interactions, and/or other activity associated with the subsequent page instance. Consequently, different combinations of event types, tracking IDs, and/or tracking scopes may be used with tracking events for the page instances and other entity instances within the web application to generate distinct entity lifecycles 118 for the instances and model relationships among the entity instances.

After groupings 216 and entity lifecycles 118 are produced, management apparatus 206 may output one or more representations of the groupings and entity lifecycles in a graphical user interface (GUI) 212. First, management apparatus 206 may display one or more visualizations 222 in GUI 212. Each visualization may include graphical representations of tracking events in an entity lifecycle. For example, the visualization may include a graph with nodes representing tracking events and/or the corresponding activities and directed edges between the nodes representing causal flows in the entity lifecycle. Multiple graphs may also be connected in the visualization to model relationships and/or scopes involving multiple entity instances.

Second, management apparatus 206 may display one or more values 224 associated with attributes 214, groupings 216, and/or entity lifecycles 118 in GUI 212. For example, management apparatus 206 may display a list, table, overlay, and/or other user-interface element containing tracking IDs, entity names, event names, event types, tracking scopes, and/or other data related to the entity instances, entity lifecycles, components in the multi-tier architecture, and/or tracking events.

To facilitate analysis of visualizations 222 and/or values 224, management apparatus 206 may provide one or more filters 230. For example, management apparatus 206 may display filters 230 for various attributes 214 along which tracking events 208-210 are grouped and/or aggregated. After one or more filters 230 are selected by a user interacting with GUI 212, management apparatus 206 may use filters 230 to update visualizations 222 and/or values 224. Consequently, the system of FIG. 2 may improve the monitoring, assessment, and management of entity instances and components in multi-tier architectures.

Those skilled in the art will appreciate that the system of FIG. 2 may be implemented in a variety of ways. As mentioned above, an “online” instance of analysis apparatus 204 may perform real-time or near-real-time processing of tracking events 208-210, and an “offline” instance of analysis apparatus 204 may perform batch or offline processing of the events. Similarly, aggregation apparatus 202, analysis apparatus 204, management apparatus 206, GUI 212, and/or data repository 234 may be provided by a single physical machine, multiple computer systems, one or more virtual machines, a grid, a cluster, one or more databases, one or more filesystems, and/or a cloud computing system. Aggregation apparatus 202, analysis apparatus 204, GUI 212, and management apparatus 206 may additionally be implemented together and/or separately by one or more hardware and/or software components and/or layers.

Moreover, the functionality of aggregation apparatus 202, analysis apparatus 204, and/or management apparatus 206 may be used with other types of data and/or monitored systems. For example, tracking events 208-210, tracking IDS 218-220, attributes 214, groupings 216, and/or entity lifecycles 118 may be used with telemetry data, sensors, applications, hardware, users, instrumentation, and/or other sources of tracking or event data.

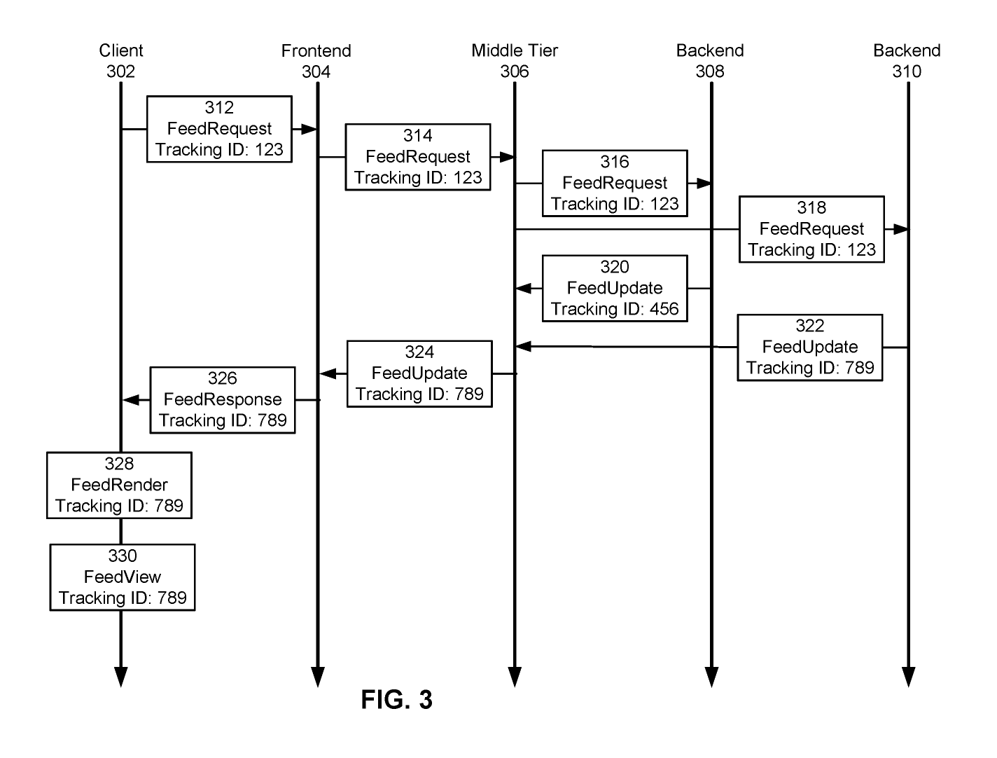

FIG. 3 shows an exemplary sequence of operations involved in tracking entity lifecycles in a multi-tier architecture in accordance with the disclosed embodiments. More specifically, FIG. 3 shows the use of tracking IDs and tracking events for activities 312-330 in the multi-tier architecture to identify entity lifecycles for a number of entity instances involved in request processing in the multi-tier architecture.

As shown in FIG. 3, a tracking event is initially generated for an activity 312 between a client 302 to a frontend 304 component. For example, activity 312 may be a request from client 302 to frontend 304 for a content feed in an online professional network and/or other application implemented using the multi-tier architecture. Activity 312 may be associated with an event type of “FeedRequest” and a tracking ID of 123 for the request. The tracking event for activity 312 may additionally include a timestamp, a duration of the request, a member ID of a member in the online professional network for which the content feed is to be generated, a browser ID of a browser used by the member to access the online professional network, a page ID of a page from which the request was generated, and/or other metadata associated with the request.

Next, a tracking event with the same tracking ID and event type is generated for an activity 314 representing a request from frontend 304 to a middle tier 306 component. The tracking event for activity 314 may contain some or all of the same metadata as tracking event 312, as well as identifiers for frontend 304 and middle tier 306.

Two tracking events with the same tracking ID and event type are then generated for activities 316-318 between middle tier 306 and two different backend 308-310 components. For example, activities 316-318 may be requests to backend components 308-310 for different types of feed updates (e.g., articles, posts, network updates, job recommendations, connection recommendations, etc.) to be included in the content feed. The corresponding tracking event for each activity 316-318 may identify middle tier 306 and the backend (e.g., backends 308-310) to which the request is directed, as well as criteria for selecting the backend as the recipient of the request. By associating tracking events for activities 312-318 with the same tracking ID of 123, client 302, frontend 304, and middle tier 306 may enable tracking and analysis of the entity lifecycle associated with the request across multiple components of the multi-tier architecture.

After receiving the requests from middle tier 306, backends 308-310 generate tracking events for activities 320-322 representing responses to the requests. The tracking event for activity 320 may have an event type of “FeedUpdate” and a tracking ID of 456, and the tracking event for activity 322 may have an event type of “FeedUpdate” and a tracking ID of 789. Thus, tracking events for activities 320-322 may indicate that the activities are of the same event type (e.g., feed updates in the content feed) but involve different entity instances (e.g., feed update instances). Each tracking event may also include information such as an identifier for a selected feed update, an identifier for a statistical model used to select the feed update, feature values used to select the feed update, a score for the feed update, and/or other context for the corresponding activity.

Middle tier 306 then processes the responses from backends 308-310 by selecting a feed update from one of the responses for inclusion in the content feed. Middle tier 306 also generates a tracking event for an activity 324 representing a response to frontend 304 that contains the selected feed update. The tracking event may have an event type of “FeedUpdate” and a tracking ID of 789, thus representing the feed update instance selected by backend 310. The tracking event may include criteria, statistical models, and/or other information used by middle tier 306 to select the feed update instance from backend 310 over the feed update instance from backend 308 for inclusion in the content feed.

Frontend 304 may relay the feed update to client 302 and generate a corresponding tracking event for an activity 326 representing a response to the initial request embodied by activity 312. The tracking event may have an event type of “FeedResponse” and a tracking ID of 789, indicating that the feed update instance from backend 310 continues to be propagated across the multi-tier architecture.

After receiving the response from frontend 304, client 302 may generate a tracking event for an activity 328 representing rendering of the feed update instance. The tracking event may have the same tracking ID of 789, an event type of “FeedRender,” and additional information such as a timestamp and/or rendering time of the feed update instance. Finally, client 302 may generate a tracking event for an activity 330 representing viewing of the feed update instance within a viewport on client 302, with the tracking event having the same tracking ID of 789 and an event type of “FeedView.” The tracking event may also specify the time of viewing, as well as the position, size, and/or other attributes of the feed update instance within the viewport. Consequently, the tracking ID of 789 may be used to generate an entity lifecycle for the feed update from backend 310.

Those skilled in the art will appreciate that some or all metadata associated with activities 312-330 may be decoupled from tracking events for activities 312-330. For example, tracking events may include a minimal set of attributes, such as entity names, event types, timestamps, durations, tracking scopes, and/or other data related to the corresponding activities. Metadata used to perform the activities may be stored in separate records and/or repositories with tracking IDs for the activities. The tracking IDs may then be used to combine the tracking events and metadata into entity lifecycles for the entity instances.

Tracking events and tracking IDs may then be used to produce a graph-based “view” of the entity lifecycles. For example, the view may include nodes representing activities 312-330 and directed edges that represent causal relationships and/or flows linking activities 312-330. Timestamps, identifiers, values, and/or other metadata may also be overlaid and/or otherwise outputted with the view to facilitate subsequent analysis of the entity lifecycles and/or dynamic optimization of the execution of the multi-tier architecture.

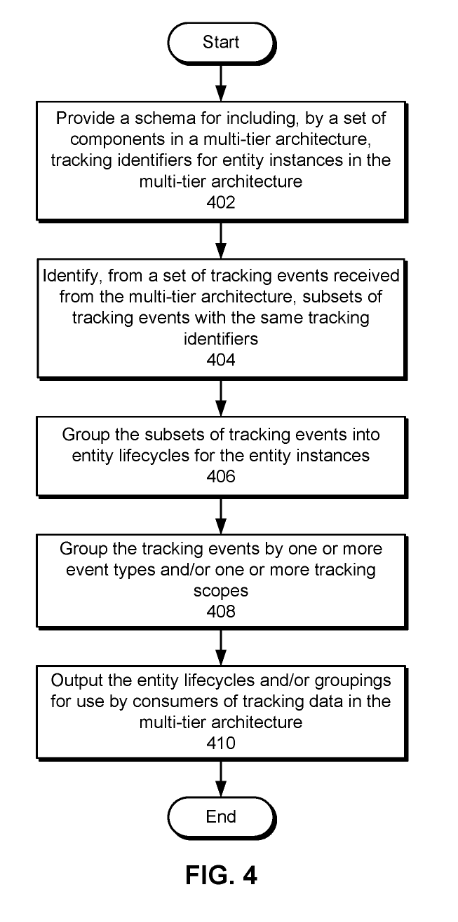

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a schema is provided for including, by a set of components in a multi-tier architecture, tracking IDs for entity instances in the multi-tier architecture (operation 402). The entity instances may include resources, user-interface elements, pages, users, data, and/or metadata in the multi-tier architecture. As the entity instances transition through different lifecycle phases, the entity instances may be created and/or used by components such as clients, frontend components, middle tier components, and/or backend components in the multi-tier architecture. In turn, the schema may standardize the tracking of activities involving the entity instances as the activities are performed by different components of the multi-tier architecture.

To enable tracking of the lifecycles of the entity instances, the tracking IDs may be passed with the entity instances among the components and used to generate tracking events representing various interactions and/or activities involving the entity instances. For example, individual tracking events for a given entity instance may be generated by multiple components in the multi-tier architecture. To associate the tracking events with the entity instance, the components may include the same tracking ID in the tracking events. A first component may create the entity instance and generate a tracking ID for the entity instance. The first component may propagate the tracking ID and/or other metadata for the entity instance to a second component that performs additional processing using the entity instance. The tracking ID may continue to be passed between the second component and additional components that interact with the entity instance until the entity instance is no longer used in the multi-tier architecture.

Because tracking IDs are maintained and propagated throughout the use of the corresponding entity instances, subsets of tracking events with the same tracking identifiers can be identified from tracking events received from the multi-tier architecture (operation 404) and grouped into entity lifecycles for the entity instances (operation 406). For example, the set of tracking events may be received in an event stream and filtered by tracking identifier. The filtered tracking events may additionally be ordered or grouped by timestamp, event type, entity name, additional identifiers, client-side data, metadata, and/or other attributes to produce entity lifecycles for the corresponding entity instances.

The tracking events can also be grouped by one or more event types and/or tracking scopes (operation 408). For example, the tracking events may be grouped by event types such as serving events, rendering events, view events, action events, interaction events, and/or navigation events. The tracking events may also or alternatively be grouped by tracking scopes associated with sessions, browsers, users, requests, pages, modules, and/or other additional entities associated with the multi-tier architecture. In other words, the tracking events may be grouped by various permutations and/or combinations of attributes to facilitate subsequent monitoring and/or analysis of the performance, operation, and/or execution of the multi-tier architecture, as well as understanding of the use of entity instances and relationships among entity instances in the multi-tier architecture.

Finally, the entity lifecycles and/or groupings are outputted for use by consumers of tracking data in the multi-tier architecture (operation 410). For example, data and/or tracking events related to the entity lifecycles may be displayed within a visualization in a GUI; included in reports, alerts, and/or notifications; used to assess the operation or performance (e.g., latency, throughput, availability, reliability, correctness, etc.) of the multi-tier architecture; and/or used to dynamically adjust the execution of the multi-tier architecture.

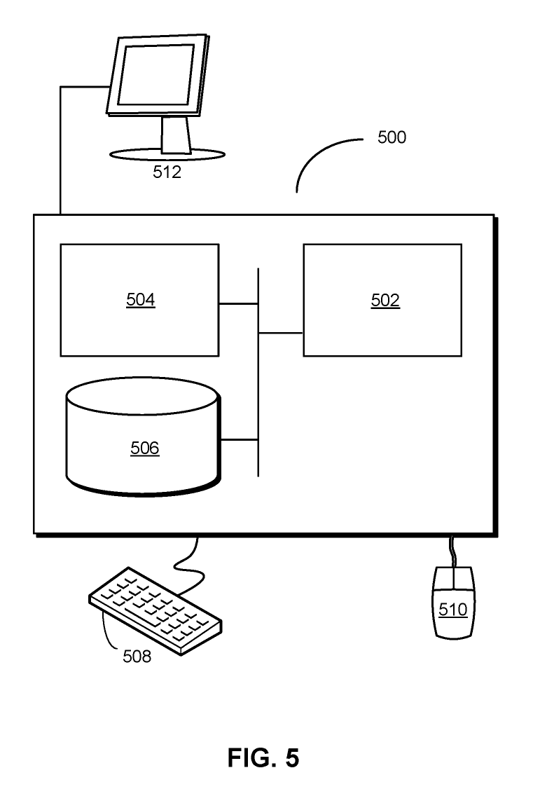

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an analysis apparatus that provides a schema for including, by a set of components in a multi-tier architecture, a tracking identifier for an entity instance in the multi-tier architecture. Next, the analysis apparatus may identify, from a set of tracking events received from the multi-tier architecture, a subset of the tracking events containing the tracking identifier. The analysis apparatus may then group the subset of the tracking events into an entity lifecycle for the entity instance. The system may also include a management apparatus that outputs the entity lifecycle for use by a consumer of tracking data in the multi-tier architecture.

In addition, one or more components of computer system 500 may be remotely located and connected to the other components over a network. Portions of the present embodiments (e.g., analysis apparatus, management apparatus, aggregation apparatus, data repository, etc.) may also be located on different nodes of a distributed system that implements the embodiments. For example, the present embodiments may be implemented using a cloud computing system that aggregates tracking events from a set of remote components in a multi-tier architecture and generates entity lifecycles for entity instances associated with the tracking events.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
providing a schema for including, by a set of components in a multi-tier architecture, a tracking identifier for an entity instance in the multi-tier architecture;
identifying, from a set of tracking events received from the multi-tier architecture, a subset of the tracking events comprising the tracking identifier;
grouping, by a computer system, the subset of the tracking events into an entity lifecycle for the entity instance; and
outputting the entity lifecycle for use in assessing a performance of the multi-tier architecture by a consumer of tracking data.

2. The method of claim 1, further comprising:
grouping the set of tracking events by one or more event types and one or more tracking scopes.

3. The method of claim 2, wherein the one or more event types comprise at least one of:
a serving event;
a rendering event;
a view event;
an action event;
an interaction event; and
a navigation event.

4. The method of claim 2, wherein the one or more tracking scopes comprise at least one of:
a session;
a browser;
a request;
a page; and
a module.

5. The method of claim 1, wherein including the tracking identifier for the entity instance in the multi-tier architecture comprises:
generating the tracking identifier at a first component associated with creating the entity instance; and
propagating the tracking identifier from the first component to a second component that performs additional processing using the entity instance.

6. The method of claim 1, wherein grouping the tracking events into the entity lifecycle for the entity comprises:
ordering the tracking events by timestamps and event types in the tracking events.

7. The method of claim 1, wherein identifying the subset of the tracking events comprising the tracking identifier comprises:
receiving the set of tracking events in an event stream; and
filtering the tracking events by the tracking identifier.

8. The method of claim 1, further comprising:
obtaining, from the set of tracking events, an additional subset of the tracking events comprising an additional tracking identifier; and
using the additional tracking identifier to group the subset into an additional entity lifecycle for an additional entity instance in the multi-tier architecture.

9. The method of claim 1, wherein the set of tracking events further comprises at least one of:
a timestamp;
an event name;
an event type;
an entity type;
a tracking scope;
an additional identifier;
client-side data; and
event metadata.

10. The method of claim 1, wherein the set of components comprises at least one of:
a client;
a frontend component;
a backend component; and
a middle tier component.

11. The method of claim 1, wherein the entity instance is at least one of:
a resource;
a user-interface element;
a page;
a user;
a statistical model;
data; and
metadata.

12. An apparatus, comprising:
one or more processors; and
memory storing instructions that, when executed by the one or more processors, cause the apparatus to:
provide a schema for including, by a set of components in a multi-tier architecture, a tracking identifier for an entity instance in the multi-tier architecture;
identifying, from a set of tracking events received from the multi-tier architecture, a subset of the tracking events comprising the tracking identifier;
group the subset of the tracking events into an entity lifecycle for the entity instance; and
output the entity lifecycle for use in assessing a performance of the multi-tier architecture by a consumer of tracking data.

13. The apparatus of claim 12, wherein the memory further stores instructions that, when executed by the one or more processors, cause the apparatus to:
group the set of tracking events by one or more event types and one or more tracking scopes.

14. The apparatus of claim 12, wherein including the tracking identifier for the entity instance in the multi-tier architecture comprises:
generating the tracking identifier at a first component associated with creating the entity instance; and
propagating the tracking identifier from the first component to a second component that performs additional processing using the entity instance.

15. The apparatus of claim 12, wherein grouping the tracking events into the entity lifecycle for the entity comprises:
ordering the tracking events by timestamps and event types in the tracking events.

16. The apparatus of claim 12, wherein identifying the subset of the tracking events comprising the tracking identifier comprises:
receiving the set of tracking events in an event stream; and
filtering the tracking events by the tracking identifier.

17. The apparatus of claim 12, wherein the entity instance is at least one of:
a resource;
a user-interface element;
a page;
a user;
a statistical model;
data; and
metadata.

18. The apparatus of claim 12, wherein the set of tracking events further comprises at least one of:
a timestamp;
an event name;
an event type;
an entity type;
a tracking scope;
an additional identifier;
client-side data; and
event metadata.

19. A system, comprising:
an analysis module comprising a non-transitory computer-readable medium comprising instructions that, when executed, cause the system to:
provide a schema for including, by a set of components in a multi-tier architecture, a tracking identifier for an entity instance in the multi-tier architecture;
identify, from a set of tracking events received from the multi-tier architecture, a subset of the tracking events comprising the tracking identifier; and
group the subset of the tracking events into an entity lifecycle for the entity instance; and
a management module comprising a non-transitory computer-readable medium comprising instructions that, when executed, cause the system to output the entity lifecycle for use in assessing a performance of the multi-tier architecture by a consumer of tracking data.

20. The system of claim 19, wherein including the tracking identifier for the entity instance in the multi-tier architecture comprises:
generating the tracking identifier at a first component associated with creating the entity instance; and
propagating the tracking identifier from the first component to a second component that performs additional processing using the entity instance.
